(19) United States
(12) Patent Application Publication
(10) Pub. No.: US 2012/0046043 A1
(43) Pub. Date: Feb. 23, 2012

(54) WIRELESS COMMUNICATION SYSTEM, RECEIVER STATION, AND WIRELESS COMMUNICATION METHOD

(75) Inventor: Daisuke JITSUKAWA, Kawasaki (JP)

(73) Assignee: FUJITSU LIMITED, Kawasaki-shi (JP)

(21) Appl. No.: 13/211,425

(22) Filed: Aug. 17, 2011

(30) Foreign Application Priority Data
Aug. 19, 2010 (JP) 2010-184404

(51) Int. Cl. H04B 7/14; H04W 4/00

(52) U.S. Cl. 455/456.1; 455/7

(57) ABSTRACT

A wireless communication system includes a transmitter station and a receiver station capable of performing wireless communication via a relay station. The relay station includes a receiver that receives the signals transmitted by the transmitter station. The relay station also includes a signal processor that performs predetermined signal processing on the signals received by the receiver, and eliminates the later one of two same signals received by the receiver. The relay station further includes a transmitter that transmits the earlier one of the two same signals to the receiver station after the signal processing performed by the signal processor.

### CROSS-REFERENCE TO RELATED APPLICATIONS

This application is based upon and claims the benefit of priority from the prior Japanese Patent Application No. 2010-184404 filed on Aug. 19, 2010, the entire contents of which are incorporated herein by reference.

### FIELD

The present invention relates to a wireless communication system, a receiver station, and a wireless communication method.

### BACKGROUND

A wireless communication system includes, for example, a transmitter station, such as a base station, and a receiver station, such as a mobile terminal device. When in a communication area covered by the transmitter station, the receiver station performs wireless communication with the transmitter station.

In recent years, in the wireless communication system, a relay station for relaying signals transmitted/received between the transmitter station and the receiver station may be installed in order to expand the communication area. An amplify-and-forward (AF) scheme is available as a relay scheme for the relay station. The relay station that performs relay processing based on the AF scheme amplifies a signal received from the transmitter station and transmits the amplified signal having the same frequency as the signal received from the transmitter station. In a wireless communication system employing such an AF scheme, the same signals transmitted from both of the transmitter station and the relay station may arrive at the receiver station in a spatially multiplexed manner. As a result, in the wireless communication system employing the AF scheme, the quality of the signals received by the receiver station may be improved. Technologies related to the wireless communication system that performs wireless communication using a relay station are disclosed in, for example, Japanese Laid-open Patent Publication No. 2003-198442, Japanese Laid-open Patent Publication No. 2007-214974, Japanese Laid-open Patent Publication No. 2008-527795, and Japanese Laid-open Patent Publication No. 2008-503907.

### SUMMARY

According to an aspect of the invention, a wireless communication system includes a transmitter station and a receiver station capable of performing wireless communication via a relay station is disclosed. The transmitter station includes a first transmitter that transmits a same signal at least twice repeatedly. The relay station includes a receiver that receives the signals transmitted by the transmitter, a signal processor that performs predetermined signal processing on the signals received by the receiver, and eliminates the later one of two same signals received by the receiver, and a second transmitter that transmits the earlier one of the two same signals to the receiver station after the signal processing performed by the signal processor.

The object and advantages of the invention will be realized and attained by means of the elements and combinations particularly pointed out in the claims.

It is to be understood that both the foregoing general description and the following detailed description are example of and explanatory and are not restrictive of the invention, as claimed.

### BRIEF DESCRIPTION OF DRAWINGS

FIG. 1 is a diagram illustrating an example of configuration of a wireless communication system according to a first embodiment;

FIG. 2 illustrates examples of signals received by a receiver station in the first embodiment;

FIG. 3 illustrates examples of signals transmitted/received by a relay station in the first embodiment;

FIG. 4 illustrates examples of signals received by the receiver station in the first embodiment;

FIG. 5 is a block diagram illustrating an example of configuration of the transmitter station in the first embodiment;

FIG. 6 is a block diagram illustrating an example of configuration of the relay station in the first embodiment;

FIG. 7 is a block diagram illustrating an example of configuration of the receiver station in the first embodiment;

FIG. 8 is a sequence diagram illustrating a procedure of processing performed by the wireless communication system according to the first embodiment;

FIG. 9 illustrates examples of signals transmitted/received by the relay station in the first embodiment;

FIG. 10 illustrates examples of signals received by the receiver station in the first embodiment;

FIG. 11 illustrates examples of signals transmitted/received by the relay station in the first embodiment;

FIG. 12 illustrates examples of signals received by the receiver station in the first embodiment; and

FIG. 13 illustrates examples of signals that a receiver station of related art receives from a transmitter station and a relay station.

### DESCRIPTION OF EMBODIMENTS

In the related art described above, there are cases in which the quality of the signals received by the receiver station deteriorates. More specifically, in the wireless communication system including the relay station, the receiver station may receive a signal resulting from interference between a signal transmitted from the transmitter station and a signal transmitted from the relay station.

A reason why the receiver station receives an interfered signal will now be described. The relay station performs predetermined signal processing on the signal received from the transmitter station. For example, the relay station performs signal processing, such as processing for amplifying the received signal, demodulation processing, and modulation processing. There are also cases in which the relay station receives the signal, transmitted to the receiver station, via a transmitter-station-oriented antenna for transmitting/receiving a signal to/from the transmitter station. Such a signal is called “diffraction waves”, which may cause the internal circuitry of the relay station to oscillate. Thus, in order to prevent the oscillation, the relay station performs digital signal processing to eliminate the diffraction waves.

Since the relay station performs various types of signal processing as described above, the relay station transmits a signal to the receiver station when a period of time taken for the signal processing passes after the reception of the signal transmitted by the transmitter station. When the delay time caused by the signal processing performed by the relay station is larger than a predetermined value, there are cases in which different signals transmitted by the transmitter and the relay station arrive at the receiver station at the same time. That is, there are cases in which the receiver station receives a signal in which the different signals transmitted by the transmitter station and the relay station are spatially multiplexed. Such a signal may cause interference, which results in a problem in that the quality of the signal received by the receiver station deteriorates.

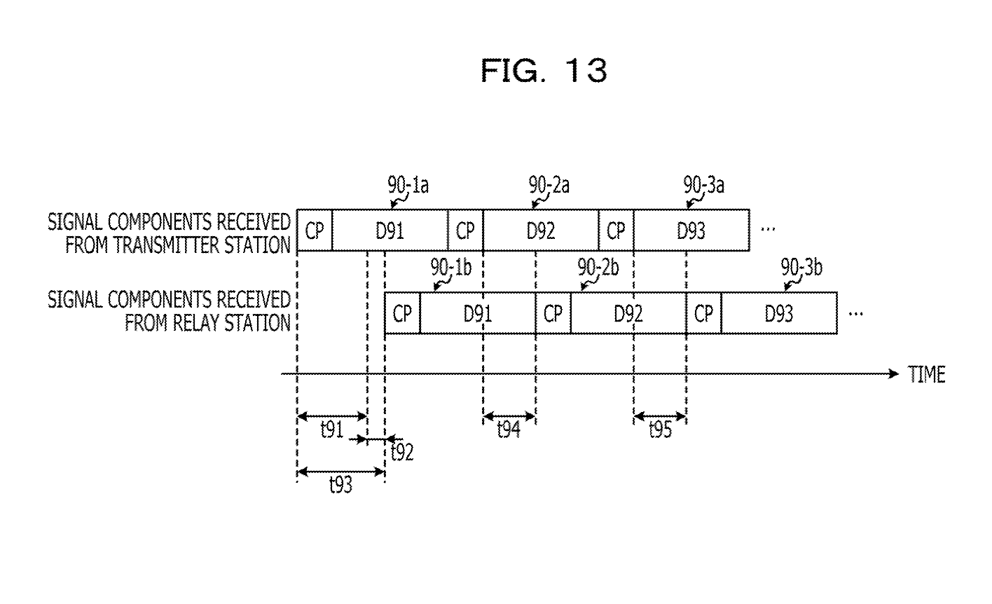

The problem will now be described with reference to FIG. 13. FIG. 13 illustrates examples of signals that a receiver station of the related art receives from a transmitter station and a relay station. In the examples illustrated in FIG. 13, it is assumed that Orthogonal Frequency Division Multiplexing (OFDM) is used as a transmission scheme. The upper stage in FIG. 13 illustrates signal components that the receiver station receives from the transmitter station and the lower stage in FIG. 13 illustrates signal components that the receiver station receives from the relay station. Although FIG. 13 illustrates an example in which the signal received by the receiver station is divided into signal components, signal components that are simultaneously received by the receiver station are spatially multiplexed in practice.

In the example illustrated in FIG. 13, the transmitter station transmits an OFDM symbol 90-1a containing a cyclic prefix (CP) and a data signal D91, an OFDM symbol 90-2a containing a CP and a data signal D92, and an OFDM symbol 90-3a containing a CP and a data signal D93. The relay station of the related art performs signal processing on the OFDM symbols 90-1a to 90-3a received from the transmitter station and then transmits signal-processed OFDM symbols 90-1b to 90-3b. The OFDM symbol 90-1b is an OFDM symbol obtained by performing the signal processing on the OFDM symbol 90-1a, the OFDM symbol 90-2b is an OFDM symbol obtained by performing the signal processing on the OFDM symbol 90-2a, and the OFDM symbol 90-3b is an OFDM symbol obtained by performing the signal processing on the OFDM symbol 90-3a.

Time “t91” illustrated in FIG. 13 indicates the amount of time taken for the signal processing performed by the relay station. Time “t92” illustrated in FIG. 13 indicates a propagation delay difference that occurs since the path from the transmitter station to the receiver station and the path from the relay station to the receiver station are different from each other. That is, the signal transmitted from the transmitter station arrives at the relay station with a delay corresponding to a time “t93=t91+t92” relative to the signal transmitted from the transmitter station.

As illustrated in FIG. 13, when the amount of delay time “t93” is larger than the duration of the CP, different OFDM symbols in the signals transmitted from the transmitter station and the relay station are spatially multiplexed to thereby cause inter-OFDM-symbol interference. More specifically, the OFDM symbol 90-1b transmitted from the relay station is spatially multiplexed with both the OFDM symbols 90-1a and 90-2a transmitted from the transmitter station and the OFDM symbol 90-2b transmitted from the relay station is spatially multiplexed with both the OFDM symbols 90-2a and 90-3a transmitted from the transmitter station. Thus, in the period of time “t94”, the receiver station receives a signal resulting from interference between the different OFDM symbols 90-2a and 90-1b, and in the period of time “t95”, the receiver station receives a signal resulting from interference between the OFDM symbols 90-3a and 90-2b. For such a reason, in the wireless communication system including the relay station, when the amount of delay caused by the signal processing performed by the transmitter station is larger than the duration of the CP, the quality of the signals received by the receiver station may deteriorate.

Embodiments of a wireless communication system, a receiver station, and a wireless communication method disclosed herein will be described below in detail with reference to the accompanying drawings. The embodiments, however, are not intended to limit the wireless communication system, the receiver station, and the wireless communication method disclosed herein. A wireless communication system that uses Orthogonal Frequency Division Multiplexing (OFDM) as one example of a transmission scheme will be described in the following embodiments by way of example. The wireless communication system disclosed herein, however, is also applicable to a wireless communication system that uses another transmission scheme, such as Orthogonal Frequency Division Multiple Access (OFDMA).

### First Embodiment

### Configuration of Wireless Communication System of First Embodiment

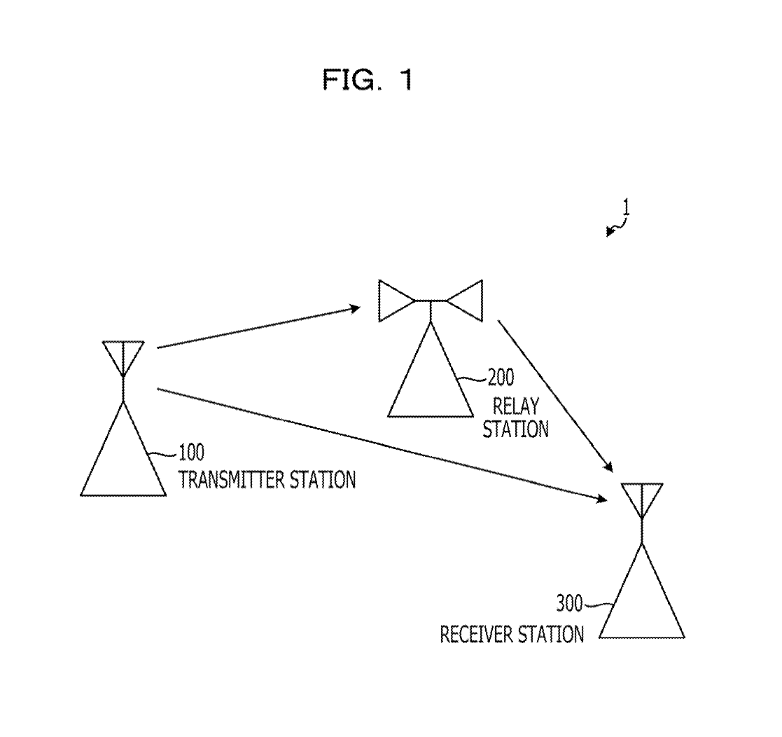

First, a wireless communication system according to a first embodiment will be described with reference to FIG. 1. FIG. 1 is a diagram illustrating an example of configuration of a wireless communication system according to a first embodiment. As illustrated in FIG. 1, a wireless communication system 1 according to a first embodiment includes a transmitter station 100, a relay station 200, and a receiver station 300.

The transmitter station 100 is, for example, a base station and transmits a signal to the receiver station 300. The transmitter station 100 transmits the same signal at least twice repeatedly. The relay station 200 and the receiver station 300 receive the signal transmitted from the transmitter station 100.

The relay station 200 in the first embodiment relays the signal, received from the transmitter station 100, to the receiver station 300. The relay station 200 performs, for example, signal processing for eliminating diffraction waves with respect to the signal received from the transmitter station 100. The relay station 200 in the first embodiment eliminates the later one of two same signals received from the transmitter station 100 and relays the earlier one thereof to the receiver station 300.

The receiver station 300 may be a mobile terminal device, such as a mobile phone, a personal handy-phone system (PHS), or a personal digital assistant (PDA). Upon receiving multiple same signals from the transmitter station 100 and the relay station 200, the receiver station 300 in the first embodiment combines the same signals.

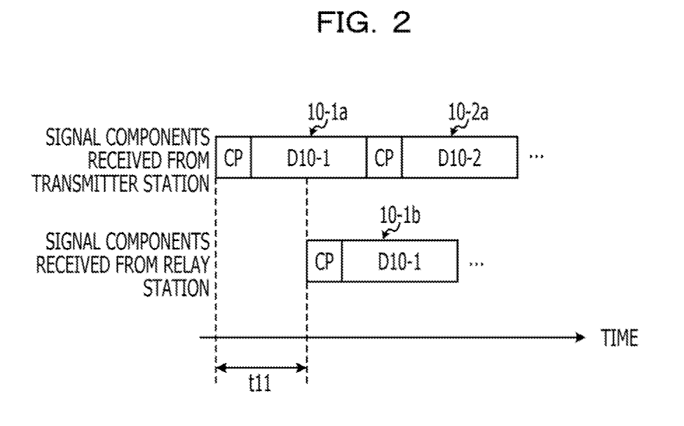

Signals received by the relay station 300 will now be described with reference to FIG. 2. FIG. 2 illustrates examples of signals received by the receiver station 300 in the first embodiment. The upper stage in FIG. 2 illustrates signal components that the receiver station 300 receives from the transmitter station 100 and the lower stage in FIG. 2 illustrates signal components that the receiver station 300 receives from the relay station 200. Although the signal components transmitted from the transmitter station 100 and the signal components transmitted from the relay station 200 are separately illustrated in FIG. 2, signal components that are simultaneously received by the receiver station 300 are spatially multiplexed in practice.

As illustrated in the upper stage in FIG. 2, the transmitter station 100 transmits an OFDM symbol 10-1a containing a CP and a data signal D10-1 and an OFDM symbol 10-2a containing a CP and a data signal D10-2. The term “data signal” as used herein refers to, for example, a control signal containing control data or a user-data signal containing user data.

In the following description, numeral “m” of “m-n” given to each OFDM symbol represents information for specifying an OFDM symbol. For example, the OFDM symbols 10-1a and 10-2a that are given the same m mean that they are the same OFDM symbol. Also, “n” of “m-n” given to each OFDM symbol represents the number of times the same OFDM symbol is transmitted by the transmitter station 100. For example, the OFDM symbol 10-1a is a first OFDM symbol transmitted by the transmitter station 100 and the OFDM symbol 10-2a is a second OFDM symbol transmitted by the transmitter station 100.

That is, in the example illustrated in FIG. 2, the transmitter station 100 transmits the same OFDM symbols 10-1a and 10-2a. The relay station 200 relays the earlier OFDM symbol 10-1a of the same OFDM symbols 10-1a and 10-2a received from the transmitter station 100 and discards the later OFDM symbol 10-2a thereof without relaying it. Specifically, the relay station 200 performs predetermined signal processing on the OFDM symbol 10-1a and transmits a signal-processed OFDM symbol 10-1b. That is, the receiver station 300 receives a signal in which the OFDM symbols 10-1a and 10-2a transmitted by the transmitter station 100 and the OFDM symbol 10-1b transmitted by the relay station 200 are spatially multiplexed as illustrated in FIG. 2.

Time “t11” illustrated in FIG. 2 is assumed to indicate a propagation delay difference due to a difference in the amount of time taken for the signal processing performed by the relay station 200 and a difference of the path. The propagation delay difference occurs since the path from the transmitter station 100 to the receiver station 300 and the path from the relay station 200 to the receiver station 300 are different from each other. Even when the amount of time “t11” is larger than the duration of the CP, the receiver station 300 in the first embodiment receives the signal in which the same OFDM symbols 10-1a, 10-2a, and 10-1b are spatially multiplexed as illustrated in FIG. 2. Thus, the receiver station 300 in the first embodiment may receive a signal that has no inter-OFDM-symbol interference.

For example, when the receiver station 300 performs processing on the signal illustrated in FIG. 2 based on a known signal transmitted from the relay station 200, the receiver station 300 obtains a signal in which the OFDM symbol 10-1b is spatially multiplexed with part of the OFDM symbols 10-1a and 10-2a. That is, the receiver station 300 may obtain a high-quality signal having no inter-OFDM-symbol interference and resulting from combination of the same signals. The aforementioned known signal is also called a “pilot signal”, a “reference signal”, or the like, and is used when the receiver station 300 or the like performs channel estimation (also called “propagation-path estimation”) and so on.

Thus, the transmitter station 100 in the first embodiment transmits the same OFDM symbol at least twice repeatedly. The relay station 200 in the first embodiment relays the earlier one of the same OFDM symbols received from the transmitter station 100 and does not relay the later one of the same OFDM symbols. As a result, in the wireless communication system 1 according to the first embodiment, the receiver station 300 may receive a signal having no inter-OFDM-symbol interference, as in the example illustrated in FIG. 2. Thus, the wireless communication system 1 according to the first embodiment may improve the quality of the signal received by the receiver station 300, even when the amount of processing delay caused by the relay station 200 is large.

Although FIG. 2 illustrates an example in which the transmitter station 100 transmits the same OFDM symbol twice repeatedly, the transmitter station 100 may transmit the same OFDM symbols three or more times repeatedly. Upon receiving three or more same OFDM symbols from the transmitter station 100, the relay station 200 may relay at least one of the OFDM symbols except the last OFDM symbol received. More specifically, upon receiving N same OFDM symbols, the relay station 200 may relay any of the OFDM symbols that are transmittable by the time the amount of time corresponding to N-times the OFDM symbol duration passes after the reception of the first one of the same OFDM symbols.

In order to ensure that the same OFDM symbols transmitted from the transmitter station 100 and the relay station 200 are to be received by the receiver station 300 at substantially the same timing, the relay station 200 may also transmit an OFDM symbol to be relayed, with a delay corresponding to a predetermined amount of time. More specifically, the relay station 200 may relay, of the same signals received from the transmitter station 100, at least one of the same signals that are transmittable by the time the duration of the same signals passes after the start of the reception of the same signals.

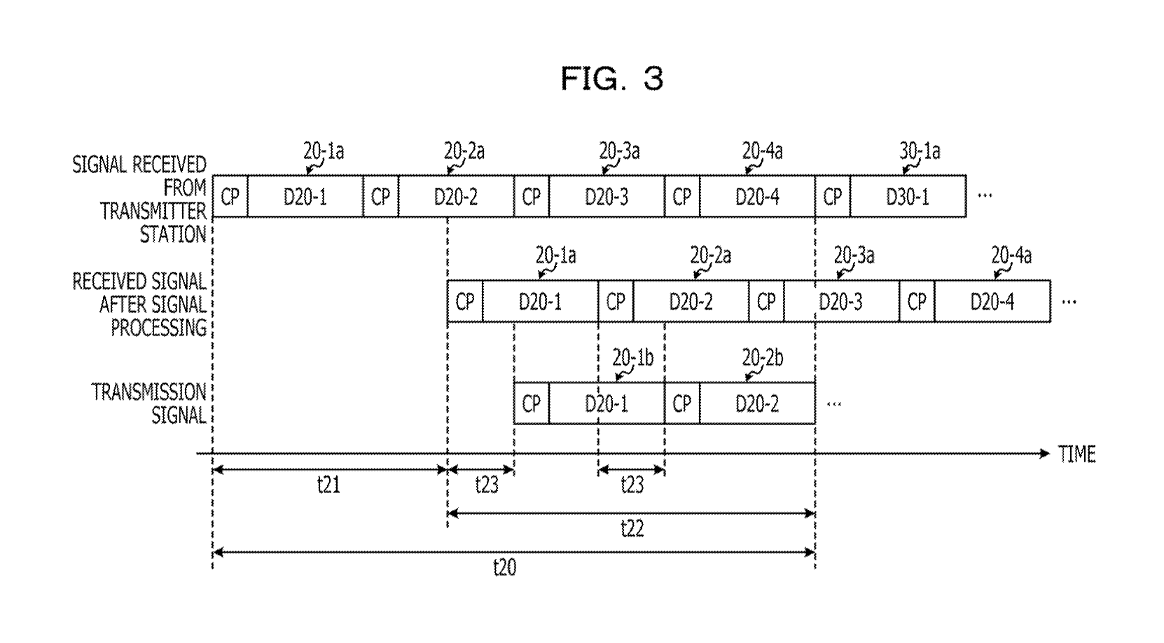

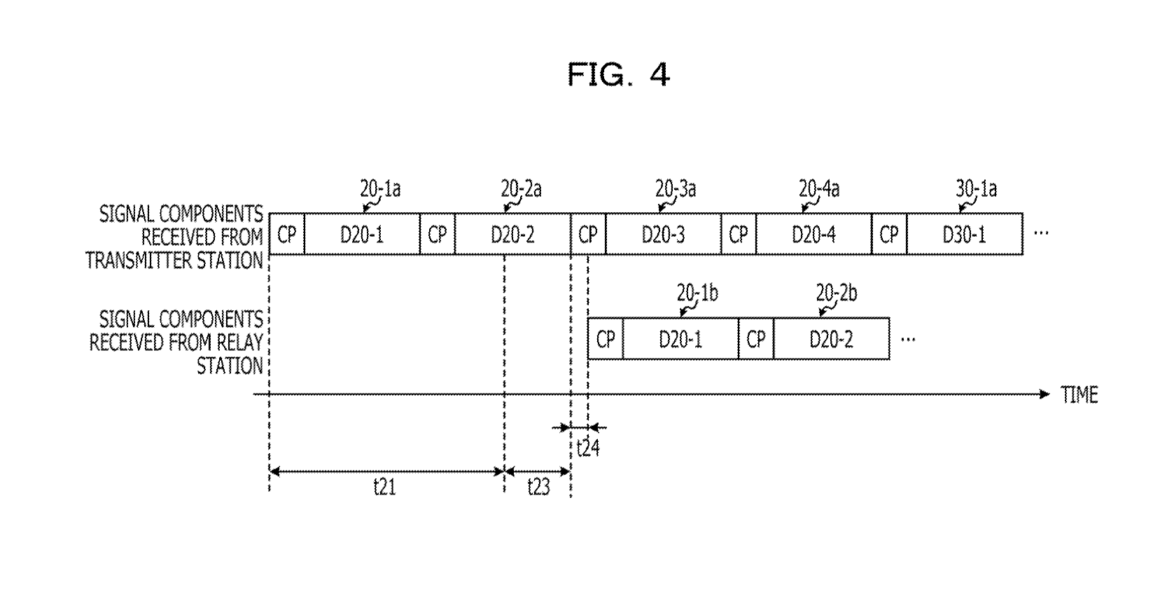

Examples of a case in which the transmitter station 100 transmits the same OFDM symbol three or more times repeatedly and a case in which the relay station 200 performs delay processing will be described below with reference to FIGS. 3 and 4.

FIG. 3 illustrates examples of signals transmitted/received by the relay station 200 in the first embodiment. The upper stage in FIG. 3 illustrates one example of a signal that the relay station 200 receives from the transmitter station 100. The middle stage in FIG. 3 illustrates an example of a signal transmitted by the relay station 200 when the relay station 200 is assumed to relay all signals. The lower stage in FIG. 3 illustrates one example of a signal relayed by the relay station 200 in the first embodiment.

In the example illustrated in FIG. 3, the transmitter station 100 transmits the same OFDM symbol four times repeatedly. In the example illustrated in the upper stage in FIG. 3, the relay station 200 receives the same OFDM symbols 20-1a to 20-4a from the transmitter station 100. Although not illustrated in FIG. 3, the relay station 200 receives OFDM symbols 30-2a to 30-4a that are the same as the OFDM symbol 30-1a transmitted from the transmitter station 100.

Time “t21” illustrated in FIG. 3 indicates the amount of time taken for the signal processing performed by the relay station 200. In this case, when the relay station 200 is assumed to relay all of the OFDM symbols 20-1a to 20-4a, the OFDM symbols 20-3a and 20-4a arrive at the receiver station 300 at the same timing as the timing of the OFDM symbol 30-1a and so on, as illustrated in the middle stage in FIG. 3. This means that the OFDM symbols 20-3a and 20-4a interfere with the other OFDM symbols 30-1a and so on, and thus the quality of the signals received by the receiver station 300 deteriorates.

Accordingly, for relaying the OFDM symbols 20-1a to 20-4a, the relay station 200 relays at least one of the OFDM symbols 20-1a and 20-2a, as illustrated in the lower stage in FIG. 3. More specifically, the relay station 200 relays the OFDM symbol(s) that are transmittable by the time an OFDM symbol duration “t20” of the OFDM symbols 20-1a to 20-4a passes after the reception of the first OFDM symbol 20-1a. In other words, the relay station 200 relays at least one of the OFDM symbols 20-1a and 20-2a that are transmittable within a time “t22” obtained by subtracting the signal processing time “t21” from the time “t20”.

In the example illustrated in FIG. 3, the relay station 200 relays both the OFDM symbols 20-1a and 20-2a. Specifically, the relay station 200 performs signal processing on the OFDM symbols 20-1a to 20-4a and transmits signal-processed OFDM symbols 20-1b and 20-2b. The OFDM symbol 20-1b is an OFDM symbol obtained by performing the signal processing on the OFDM symbol 20-1a and the OFDM symbol 20-2b is an OFDM symbol obtained by performing the signal processing on the OFDM symbol 20-2a.

Since the symbol duration “t20” of the OFDM symbols 20-1a to 20-4a is the duration of four OFDM symbols, it is known to the relay station 200. It is also assumed that the signal processing time “t21” is, for example, an amount of time measured during manufacture of the relay station 200 and is known to the relay station 200. For example, the relay station 200 stores, in a predetermined storage unit, the signal processing time “t21” measured during the manufacture. Thus, using the known time “t20” and the signal processing time “t21”, the relay station 200 may determine the time “t22”.

The relay station 200 performs delay processing so that the difference between the time at which the OFDM symbol transmitted from the transmitter station 100 arrives at the receiver station 300 and the time at which the OFDM symbol transmitted by the relay station 200 arrives at the receiver station 300 is smaller than or equal to the CP duration. More specifically, the relay station 200 performs relay processing so that the difference between the time at which the OFDM symbols 20-1b and 20-2b arrive at the receiver station 300 and the time at which any of the OFDM symbols 20-1a to 20-4a arrives at the receiver station 300 is smaller than or equal to the CP duration. In the example illustrated in FIG. 3, after completing the signal processing, the relay station 200 transmits the OFDM symbol 20-1b with a delay corresponding to a time “t23”. Similarly, after completing the signal processing, the relay station 200 transmits the OFDM symbol 20-2b with a delay corresponding to the time “t23”.

The relay station 200 may determine the delay time “t23” by subtracting the signal processing time “t21” from an integer multiple of the duration of the OFDM symbol. For example, when the signal processing time “t21” is larger than the duration of one OFDM symbol and is smaller than the duration of two OFDM symbols, as illustrated in FIG. 3, the relay station 200 determines the delay time “t23” by subtracting the signal processing time “t21” from twice the duration of the OFDM symbol. That is, when a signal processing time “X” is in the range of Y times the duration of the OFDM symbol to Z times the duration of the OFDM symbol, the relay station 200 determines the delay time by subtracting the signal processing time “X” from Z times the duration of the OFDM symbol. Y and Z are successive integers.

Next, signals received by the receiver station 300 when the signal illustrated in the lower stage in FIG. 3 is relayed by the relay station 200 will be described with reference to FIG. 4. FIG. 4 illustrates examples of signals received by the receiver station 300 in the first embodiment. The upper stage in FIG. 4 illustrates signal components that the receiver station 300 receives from the transmitter station 100 and the lower stage in FIG. 4 illustrates signal components that the receiver station 300 receives from the relay station 200. Time “t24” illustrated in FIG. 4 indicates a propagation delay difference that occurs since the path from the transmitter station 100 to the receiver station 300 and the path from the relay station 200 to the receiver station 300 are different from each other.

As illustrated in FIG. 4, the receiver station 300 receives a signal in which the OFDM symbols 20-1a to 20-4a and so on transmitted by the transmitter station 100 and the OFDM symbols 20-1b and 20-2b transmitted by the relay station 200 are spatially multiplexed. More specifically, the OFDM symbol 20-1b transmitted by the relay station 200 is spatially multiplexed with the OFDM symbol 20-3a and the CP in the OFDM symbol 20-4a, the symbols 20-3a and 20-4a being transmitted by the transmitter station 100. The OFDM symbol 20-2b transmitted by the relay station 200 is also spatially multiplexed with the OFDM symbol 20-4a and the CP in the OFDM symbol 30-1a, the symbols 20-4a and 30-1a being transmitted by the transmitter station 100.

The OFDM symbol 20-2b and the OFDM symbol 30-1a, which are OFDM symbols that are different from each other, do not interfere with each other since the OFDM symbol 20-2b and the OFDM symbol 30-1a are spatially multiplexed within the range of the CP duration.

In such a manner, the receiver station 300 receives, from the transmitter station 100 and the relay station 200, a signal in which the same OFDM symbols are spatially multiplexed. Thus, the receiver station 300 in the first embodiment may receive a signal having no inter-OFDM-symbol interference.

In addition, since the relay station 200 transmits the OFDM symbol 20-1b with a delay corresponding to the time “t23”, the propagation delay difference between the OFDM symbol 20-3a and the OFDM symbol 20-1b is within the CP duration. Similarly, the propagation delay difference between the OFDM symbol 20-4a and the OFDM symbol 20-2b is within the CP duration.

As a result, the receiver station 300 may extract a signal for each OFDM symbol even when using any of known signals transmitted by the transmitter station 100 or the relay station 200. For example, in the example illustrated in FIG. 4, when using a known signal transmitted from the transmitter station 100, the receiver station 300 may obtain the signal in which the OFDM symbols 20-3a and 20-1b are spatially multiplexed. For example, when using a known signal transmitted from the relay station 200, the receiver station 300 may obtain the signal in which the OFDM symbols 20-3a and 20-1b are spatially multiplexed. Similarly, even when using a known signal transmitted from the transmitter station 100 or the relay station 200, the receiver station 300 may obtain a signal in which the OFDM symbols 20-4a and 20-2b are spatially multiplexed.

Upon receiving the OFDM symbols illustrated in FIG. 4, the receiver station 300 combines the same OFDM symbols of the received OFDM symbols. More specifically, upon receiving the OFDM symbol 20-1a, the receiver station 300 stores the OFDM symbol 20-1a in a predetermined buffer. Similarly, the receiver station 300 stores the OFDM symbol 20-2a in the buffer. The receiver station 300 also stores, in the buffer, the OFDM symbol in which the OFDM symbols 20-3a and 20-1b are spatially multiplexed and the OFDM symbol in which the OFDM symbols 20-4a and 20-2b are spatially multiplexed. The receiver station 300 then combines the OFDM symbols stored in the buffer. The receiver station 300 performs, for example, log-likelihood ratio (LLR) combining processing for combining likelihood information of the same data contained in the OFDM symbols.

As described above, the receiver station 300 in the first embodiment may receive a signal having no inter-OFDM-symbol interference and may also improve the reception characteristics by combining the OFDM symbols.

Although no description has been given above, the relay station 200 in the wireless communication system 1 in the first embodiment may relay the signal to a specific receiver station and does not need to relay the signal to a receiver station other than the specific receiver station. The transmitter station 100 may perform processing for repeatedly transmitting the same signal to the specific receiver station and does not necessarily have to perform processing for repeatedly transmitting the same signal to a receiver station other than the specific receiver station.

[Configuration of Transmitter Station in First Embodiment]

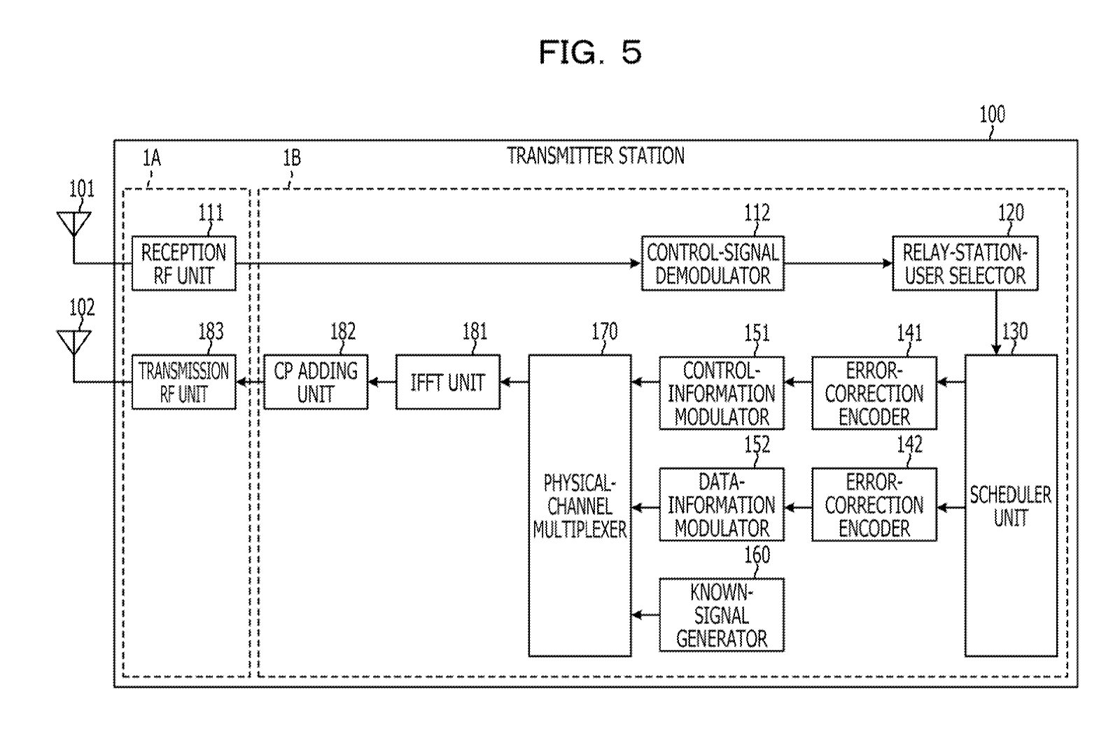

The transmitter station 100 in the first embodiment will be described next with reference to FIG. 5. FIG. 5 is a block diagram of an example of configuration of the transmitter station 100 in the first embodiment. As illustrated in FIG. 5, the transmitter station 100 includes antennas 101 and 102, a reception radio-frequency (RF) unit 111, a control-signal demodulator 112, and a relay-station-user selector 120.

The antenna 101 receives a signal transmitted from an external apparatus (not illustrated). The antenna 101 receives, for example, an uplink signal transmitted from the receiver station 300. The antenna 102 transmits a signal to an external apparatus (not illustrated). For example, the antenna 102 transmits a downlink signal to the relay station 200 and the receiver station 300. Although FIG. 5 illustrates an example in which the transmitter station 100 has both the receive antenna 101 and the transmit antenna 102, the transmitter station 100 may have a shared antenna via which transmission and reception are possible, instead of the receive antenna 101 and the transmit antenna 102.

The reception RF unit 111 performs various types of processing on the signal received by the antenna 101. Examples of the processing that the reception RF unit 111 performs on the signal received by the antenna 101 include frequency conversion processing for converting a radio frequency band into a baseband, orthogonal demodulation processing, and analog-to-digital (A/D) conversion processing.

The control-signal demodulator 112 performs demodulation processing and the like on, of the signals output from the reception RF unit 111, the control signal transmitted by the receiver station 300. The control signal transmitted by the receiver station 300 contains position information indicating the location of the receiver station 300. Upon receiving the control signal containing the position information from the receiver station 300, the control-signal demodulator 112 extracts the receiver station 300 position information from the control signal.

Based on the receiver station 300 position information output from the control-signal demodulator 112, the relay-station-user selector 120 determines whether or not the receiver station 300 is to be set as a receiver station for receiving a signal relayed by the relay station 200. The receiver station for receiving the signal relayed by the relay station 200 may be referred to as a “relay-station user” hereinafter.

More specifically, when the distance between the receiver station 300 and the relay station 200 is smaller than a predetermined threshold, the relay-station-user selector 120 determines that the receiver station 300 is to be set as the relay-station user. On the other hand, when the distance between the receiver station 300 and the relay station 200 is larger than or equal to the predetermined threshold, the relay-station-user selector 120 determines that the receiver station 300 is not to be set as the relay-station user. This is because, when the receiver station 300 and the relay station 200 are not located a short distance from each other, there are, for example, a case in which the receiver station 300 is not located within the communication area of the relay station 200 and a case in which the receiver station 300 may not receive the signal, relayed by the relay station 200, with a high quality.

The transmitter station 100 also receives a data signal containing user data and so on and performs reception processing on the data signal. A description of the reception processing performed on the data signal including user data and so on is omitted in FIG. 4.

As illustrated in FIG. 5, the transmitter station 100 further includes a scheduler unit 130, error-correction encoders 141 and 142, a control-information modulator 151, a data-information modulator 152, a known-signal generator 160, and a physical-channel multiplexer 170. The transmitter station 100 further includes an inverse fast Fourier transform (IFFT) unit 181, a cyclic prefix (CP) adding unit 182, and a transmission RF unit 183.

The scheduler unit 130 assigns control data, user data, and so on to be transmitted to the receiver station 300 to resources. More specifically, the scheduler unit 130 performs processing for assigning control data to be transmitted to the receiver station 300 to resources and processing for assigning user data to be transmitted to the receiver station 300 to resources. The processing performed by the scheduler unit 130 will be described below as separately as the processing for assigning control data to resources and the processing for assigning user data to resources.

The processing for assigning control data to resources will be described first. The scheduler unit 130 outputs, to the error-correction encoder 141, control data containing, such as resource assignment information regarding resources to which user data and so on are assigned.

In this case, when the relay-station-user selector 120 determines that the receiver station 300 is to be set as the relay-station user, the scheduler unit 130 outputs, to the error-correction encoder 141, information indicating that the receiver station 300 is the relay-station user. The information indicating whether or not the receiver station 300 is the relay-station user may hereinafter be referred to as “relay-station-user information”.

When the relay-station-user selector 120 determines that the receiver station 300 is to be set as the relay-station user, the scheduler unit 130 outputs, to the error-correction encoder 141, the number “N” of times the same signal is to be repeatedly transmitted. The number of times the transmitter station 100 repeatedly transmits the same signal may hereinafter be referred to as the “number of repeated transmissions”.

When the relay-station-user selector 120 determines that the receiver station 300 is to be set as the relay-station user, the scheduler unit 130 assigns control information to resources so that the same control data is repeatedly transmitted to the receiver station 300. In this case, the scheduler unit 130 assigns the control data to the resources so that the same control data is transmitted to the receiver station 300 according to the number “N” of repeated transmissions.

On the other hand, when the relay-station-user selector 120 determines that the receiver station 300 is not to be set as the relay-station user, the scheduler unit 130 outputs, to the error-correction encoder 141, relay-station user information indicating that the receiver station 300 is not the relay-station user. When the relay-station-user selector 120 determines that the receiver station 300 is not to be set as the relay-station user, the scheduler unit 130 outputs the number “N” of repeated transmissions which indicates “1” to the error-correction encoder 141.

When the relay-station-user selector 120 determines that the receiver station 300 is not to be set as the relay-station user, the scheduler unit 130 assigns the control data to the resources so that the same control data is transmitted to the receiver station 300 only once.

The processing for assigning data information to resources will be described next. When the relay-station-user selector 120 determines that the receiver station 300 is to be set as the relay-station user, the scheduler unit 130 assigns user data to resources so that the same user data is repeatedly transmitted to the receiver station 300. In this case, the scheduler unit 130 assigns the user data to the resources so that the same user data is transmitted to the receiver station 300 according to the number “N” of repeated transmissions.

When the relay-station-user selector 120 determines that the receiver station 300 is not to be set as the relay-station user, the scheduler unit 130 assigns the user data to the resources so that the same user data is transmitted to the receiver station 300 only once.

The error-correction encoder 141 performs error-correction encoding processing on the control data assigned to the resources by the scheduler unit 130. The error-correction encoder 142 performs error-correction encoding processing on the user data assigned to the resources by the scheduler unit 130.

The control-information modulator 151 generates a control signal by performing modulation processing on the control data on which the error-correction encoding processing was performed by the error-correction encoder 141. The data-information modulator 152 generates a user-data signal by performing modulation processing on the user data on which the error-correction encoding processing was performed by the error-correction encoder 142.

The known-signal generator 160 generates a known signal that is known to the receiver station 300. The known signal generated by the known-signal generator 160 is also called a “pilot signal” or “reference signal” and is used when the receiver station 300 performs channel estimation processing and so on.

The physical-channel multiplexer 170 frequency-multiplexes the various signals mapped onto subcarriers. The physical-channel multiplexer 170 frequency-multiplexes the control signal output from the control-information modulator 151, the user-data signal output from the data-information modulator 152, and the known signal output from the known-signal generator 160.

The IFFT unit 181 generates a time-domain signal by performing IFFT processing on the frequency-domain signal frequency-multiplexed by the physical-channel multiplexer 170. The CP adding unit 182 divides the signal, generated by the IFFT unit 181, into signals according to an OFDM symbol duration, and adds a CP to each of the signals having the OFDM symbol duration.

The transmission RF unit 183 performs various types of processing on the signal output from the CP adding unit 182. Examples of the processing that the transmission RF unit 183 performs on the signal output from the CP adding unit 182 include digital-to-analog (D/A) conversion processing, orthogonal modulation processing, and frequency conversion processing for converting a baseband into a radio frequency band. The transmission RF unit 183 outputs a signal, obtained by the various types of processing, via the antenna 102.

An RF processing unit 1A that includes the reception RF unit 111 and the transmission RF unit 183 may be realized by hardware, for example, an integrated circuit, such as an application specific integrated circuit (ASIC) or a field programmable gate array (FPGA). The control-signal demodulator 112, the relay-station-user selector 120, the scheduler unit 130, the error-correction encoders 141 and 142, the control-information modulator 151, the data-information modulator 152, the known-signal generator 160, the physical-channel multiplexer 170, the IFFT unit 181, and the CP adding unit 182 are included in a baseband processor 1B, which may be realized by, for example, hardware, such as a central processing unit (CPU) or a micro processing unit (MPU). That is, the RF processor 1A and the baseband processor 1B may be realized by pieces of hardware that are different from each other.

[Configuration of Relay Station in First Embodiment]

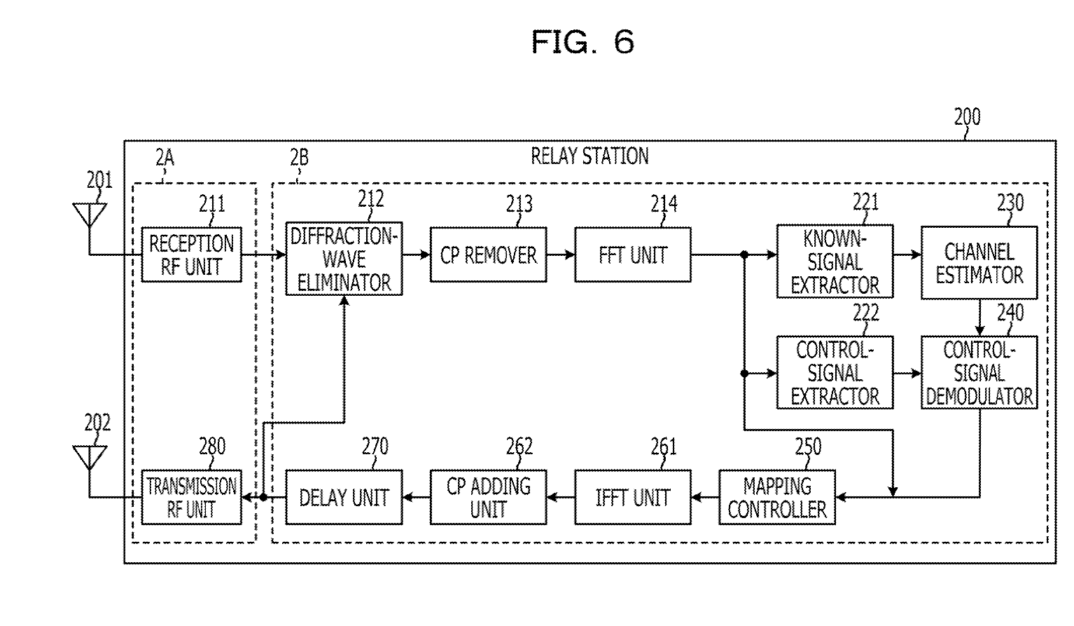

The relay station 200 in the first embodiment will be described next with reference to FIG. 6. FIG. 6 is a block diagram illustrating an example of configuration of the relay station 200 in the first embodiment. As illustrated in FIG. 6, the relay station 200 includes antennas 201 and 202, a reception RF unit 211, a diffraction-wave eliminator 212, a CP remover 213, and a fast Fourier transform (FFT) unit 214.

The antenna 201 receives a signal transmitted from an external apparatus (not illustrated). The antenna 201 receives, for example, a signal transmitted from the transmitter station 100. The antenna 202 transmits a signal to an external apparatus (not illustrated). The antenna 202 transmits a signal to, for example, the receiver station 300. The relay station 200 may have a shared antenna via which transmission and reception are possible, instead of the antennas 201 and 202.

In the example illustrated in FIG. 6, the signal transmitted from the transmit antenna 202 may be received, as diffraction waves, by the receive antenna 201. When received by the receive antenna 201, such diffraction waves may cause internal circuitry of the relay station 200 to oscillate.

The reception RF unit 211 performs various types of processing on the signal received by the antenna 201. For example, similarly to the reception RF unit 111 illustrated in FIG. 5, the reception RF unit 211 performs frequency conversion processing, orthogonal demodulation processing, A/D conversion processing, and so on.

By using the signal output from a delay unit 270 (described below), the diffraction-wave eliminator 212 eliminates diffraction waves from the signal input from the reception RF unit 211. With this arrangement, even when the antenna 201 receives diffraction waves, the diffraction-wave eliminator 212 may prevent the internal circuitry of the relay station 200 from oscillating.

The CP remover 213 removes the CP from the signal output from the diffraction-wave eliminator 212. The FFT unit 214 performs FFT processing on a signal, output from the CP remover 213, to generate a frequency-domain signal.

As illustrated in FIG. 6, the relay station 200 includes a known-signal extractor 221, a control-signal extractor 222, a channel estimator 230, a control-signal demodulator 240, and a mapping controller 250.

The known-signal extractor 221 extracts the known signal from the frequency-domain signal generated by the FFT unit 214. The control-signal extractor 222 extracts the control signal from the frequency-domain signal generated by the FFT unit 214.

The channel estimator 230 performs channel estimation processing based on the known signal extracted by the known-signal extractor 221. The control-signal demodulator 240 performs, for example, channel-compensation processing, demodulation processing, and error-correction decoding processing on the control signal extracted by the control-signal extractor 222. As a result, the control-signal demodulator 240 extracts the resource assignment information, the relay-station user information, the number of repeated transmissions, and so on from the control signal transmitted by the transmitter station 100. The control-signal demodulator 240 outputs the resource assignment information, the relay-station user information, the number of repeated transmissions, and so on to the mapping controller 250.

Based on the multiple types of information output from the control-signal demodulator 240, the mapping controller 250 performs processing for adjusting the mapping positions of subcarriers with respect to the frequency-domain signal output from the FFT unit 214.

More specifically, the mapping controller 250 determines whether or not the receiver station 300 is the relay-station user, based on the relay-station-user information output from the control-signal demodulator 240. When the receiver station 300 is not the relay-station user, the mapping controller 250 substitutes “0” for, of the signals output from the FFT unit 214, the signal destined for the receiver station 300. This is because, when the receiver station 300 is not the relay-station user, the relay station 200 does not relay the signal, received from the transmitter station 100 and destined for the receiver station 300, to the receiver station 300.

On the other hand, when the receiver station 300 is the relay-station user, the mapping controller 250 relays, of the same signals contained in the signals destined for the receiver station 300, at least one of the signals that are transmittable by the time the duration of the same signals passes. More specifically, the mapping controller 250 substitutes “0” for the signals that are not to be relayed.

As illustrated in FIG. 6, the relay station 200 further includes an IFFT unit 261, a CP adding unit 262, a delay unit 270, and a transmission RF unit 280. The IFFT unit 261 performs IFFT processing on a signal, output from the mapping controller 250, to generate a time-domain signal. The CP adding unit 262 divides the signal, generated by the IFFT unit 261, into signals according to an OFDM symbol duration, and adds a CP to each of the signals having the OFDM symbol duration.

After waiting for a period of delay time obtained by subtracting a predetermined signal processing time from the integer multiple of the duration of the OFDM symbol, the delay unit 270 outputs the OFDM symbols, output from the CP adding unit 262, to the transmission RF unit 280. More specifically, when a signal processing time “X” is in the range of Y times the duration of the OFDM symbol to Z times the duration of the OFDM symbol, the delay unit 270 waits for a period of delay time obtained by subtracting the signal processing time “X” from Z times the duration of the OFDM symbol, as described above. The signal processing time “X” corresponds to, for example, the time from when the antenna 201 receives the signal until the CP adding unit 262 completes the CP addition processing.

The transmission RF unit 280 performs various types of processing on the signal output from the delay unit 270. For example, similarly to the transmission RF unit 183 illustrated in FIG. 5, the transmission RF unit 280 performs D/A conversion processing, orthogonal modulation processing, frequency conversion processing, and so on.

The reception RF unit 211 and the transmission RF unit 280 are included in an RF processor 2A, which may be realized by hardware, for example, an integrated circuit, such as an ASIC or FPGA. The diffraction-wave eliminator 212, the CP remover 213, the FFT unit 214, the known-signal extractor 221, the control-signal extractor 222, the channel estimator 230, the control-signal demodulator 240, the mapping controller 250, the IFFT unit 261, the CP adding unit 262, and the delay unit 270 are included in a baseband processor 2B, which may be realized by hardware, such as a CPU or MPU. That is, the RF processor 2A and the baseband processor 2B may be realized by pieces of hardware that are different from each other.

[Configuration of Receiver Station in First Embodiment]

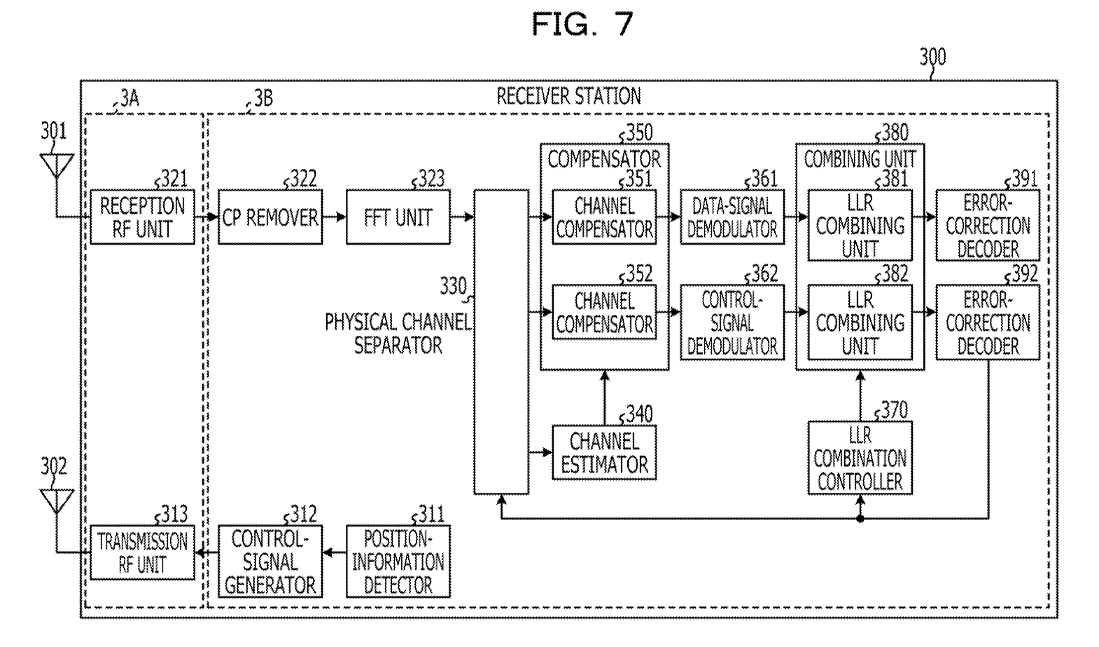

The receiver station 300 in the first embodiment will be described next with reference to FIG. 7. FIG. 7 is a block diagram illustrating an example of configuration of the receiver station 300 in the first embodiment. As illustrated in FIG. 7, the receiver station 300 includes antennas 301 and 302, a position-information detector 311, a control-signal generator 312, and a transmission RF unit 313.

The antenna 301 receives a signal transmitted from an external apparatus (not illustrated). For example, the antenna 301 receives a downlink signal transmitted from the transmitter station 100 and the relay station 200. The antenna 302 transmits a signal to an external apparatus (not illustrated). For example, the antenna 302 transmits an uplink signal to the transmitter station 100. The receiver station 300 may have a shared antenna via which transmission and reception are possible, instead of the antennas 301 and 302.

The position-information detector 311 detects the location of the receiver station 300. For example, the position-information detector 311 detects the location of the receiver station 300, for example, by receiving signals transmitted from global positioning system (GPS) satellites. The position-information detector 311 then outputs position information indicating the location of the receiver station 300 to the control-signal generator 312.

The control-signal generator 312 in the first embodiment generates a control signal. More specifically, the control-signal generator 312 generates a control signal containing the receiver station 300 position information detected by the position-information detector 311.

The transmission RF unit 313 performs various types of processing on the control signal generated by the control-signal generator 312. For example, similarly to the transmission RF unit 183 illustrated in FIG. 5, the transmission RF unit 313 performs D/A conversion processing, orthogonal modulation processing, frequency conversion processing, and so on. The transmission RF unit 313 transmits the control signal, obtained by the frequency conversion processing, to the transmitter station 100 via the antenna 302.

The receiver station 300 also performs processing for generating a data signal containing user data and so on and transmitting the data signal containing the user data and so on. A description of the processing for transmitting the data signal containing the user data and so on is omitted in FIG. 7.

As illustrated in FIG. 7, the receiver station 300 includes a reception RF unit 321, a CP remover 322, an FFT unit 323, and a physical channel separator 330. The reception RF unit 321 performs various types of processing on the signal received by the antenna 301. For example, similarly to the reception RF unit 111 illustrated in FIG. 5, the reception RF unit 321 performs frequency conversion processing, orthogonal demodulation processing, A/D conversion processing, and so on.

The CP remover 322 removes the CP from the signal output from the reception RF unit 321. The FFT unit 323 performs FFT processing on a signal, output from the CP remover 322, to generate a frequency-domain signal.

The physical-channel separator 330 receives, from the FFT unit 323, the signal in which physical channels are frequency-multiplexed, and separates the frequency-multiplexed signal into a known signal, a control signal, and a data signal. The physical-channel separator 330 receives the control information from the error-correction decoder 392 and performs physical-channel separating processing based on the resource assignment information contained in the control information.

As illustrated in FIG. 7, the receiver station 300 further includes a channel estimator 340, a compensator 350, a data-signal demodulator 361, a control-signal demodulator 362, an LLR combination controller 370, a combining unit 380, and error-correction decoders 391 and 392.

The channel estimator 340 performs channel estimation processing based on the known signal extracted by the physical-channel separator 330. More specifically, the channel estimator 340 estimates a wireless channel state by determining the correlation between the known signal transmitted from the transmitter station 100 and the signal known to the receiver station 300.

The compensator 350 includes channel compensators 351 and 352. Based on a result of the channel estimation processing performed by the channel estimator 340, the channel estimator 351 performs channel compensation on the data signal extracted by the physical-channel separator 330. Based on a result of the channel estimation processing performed by the channel estimator 340, the channel compensator 352 performs channel compensation on the control signal extracted by the physical-channel separator 330.

The data-signal demodulator 361 performs demodulation processing on the data signal channel-compensated by the channel compensator 351. The control-signal demodulator 362 performs demodulation processing on the control signal channel-compensated by the channel compensator 352.

Based on the relay-station-user information and the number of repeated transmissions, the information and the number being output from the error-correction decoder 392, the LLR combination controller 370 controls the combination processing performed by the combining unit 380. More specifically, the LLR combination controller 370 determines whether or not the receiver station 300 that is the local station is the relay-station user, based on the relay-station-user information output from the error-correction decoder 392. When the local station is the relay-station user, the LLR combination controller 370 outputs the number of repeated transmissions to the combining unit 380 and controls the combining unit 380 so that it performs the combination processing. On the other hand, when the local station is not the relay-station user, the LLR combination controller 370 controls the combining unit 380 so that it does not perform the combination processing.

The combining unit 380 includes LLR combining units 381 and 382. When the LLR combining unit 381 is controlled by the LLR combination controller 370 so as not to perform the combination processing, the LLR combining unit 381 outputs the user-data signal, input from the data-signal demodulator 361, to the error-correction decoder 391.

On the other hand, when the LLR combining unit 381 is controlled by the LLR combination controller 370 so as to perform the combination processing, the LLR combining unit 381 combines the user-data signals input from the data-signal demodulator 361. In this case, the same user-data signal is repeatedly input from the data-signal demodulator 361 to the LLR combining unit 381 according to the number “N” of repeated transmissions which is output from the LLR combination controller 370. In this case, the LLR combining unit 381 stores, in a predetermined buffer, the same user-data signals input from the data-signal demodulator 361. For example, after storing all the same user-data signals in the buffer, the LLR combining unit 381 performs LLR combination processing on the user-data signals in the buffer. The LLR combining unit 381 then outputs the user-data signals, obtained by the LLR combination processing, to the error-correction decoder 391.

When the LLR combining unit 382 is controlled by the LLR combination controller 370 so as not to perform the combination processing, the LLR combining unit 382 outputs the control signal, input from the control-signal demodulator 362, to the error-correction decoder 392. On the other hand, when the LLR combining unit 382 is controlled by the LLR combination controller 370 so as to perform the combination processing, the LLR combining unit 382 receives the same control signals from the control-signal demodulator 362 and performs the LLR combination processing on the same control signals. The LLR combining unit 382 then outputs the control signal, obtained by the LLR combination processing, to the error-correction decoder 392.

The error-correction decoder 391 performs error-correction decoding processing on the data signal output from the LLR combining unit 381. As a result, the error-correction decoder 391 obtains the user data from the user-data signal.

The error-correction decoder 392 performs error-correction decoding processing on the control signal output from the LLR combining unit 382. As a result, the error-correction decoder 392 obtains, from the control signal, the control information containing the resource-assignment information, the relay-station-user information, the number of repeated transmissions, and so on. The error-correction decoder 392 outputs the various types of information contained in the control information to the LLR combination controller 370 and the physical-channel separator 330.

The reception RF unit 321 and the transmission RF unit 313 are included in an RF processor 3A, which may be realized by hardware, for example, an integrated circuit, such as an ASIC or FPGA. The position-information detector 311, the control-signal generator 312, the CP remover 322, the FFT unit 323, the physical channel separator 330, the channel estimator 340, the compensator 350, the data-signal demodulator 361, the control-signal demodulator 362, the LLR combination controller 370, the combining unit 380, and the error-correction decoders 391 and 392 are included in a baseband processor 3B, which may be realized by hardware, such as a CPU or MPU. That is, the RF processor 3A and the baseband processor 3B may be realized by pieces of hardware that are different from each other.

[Sequence of Processing Performed by Wireless Communication System of First Embodiment]

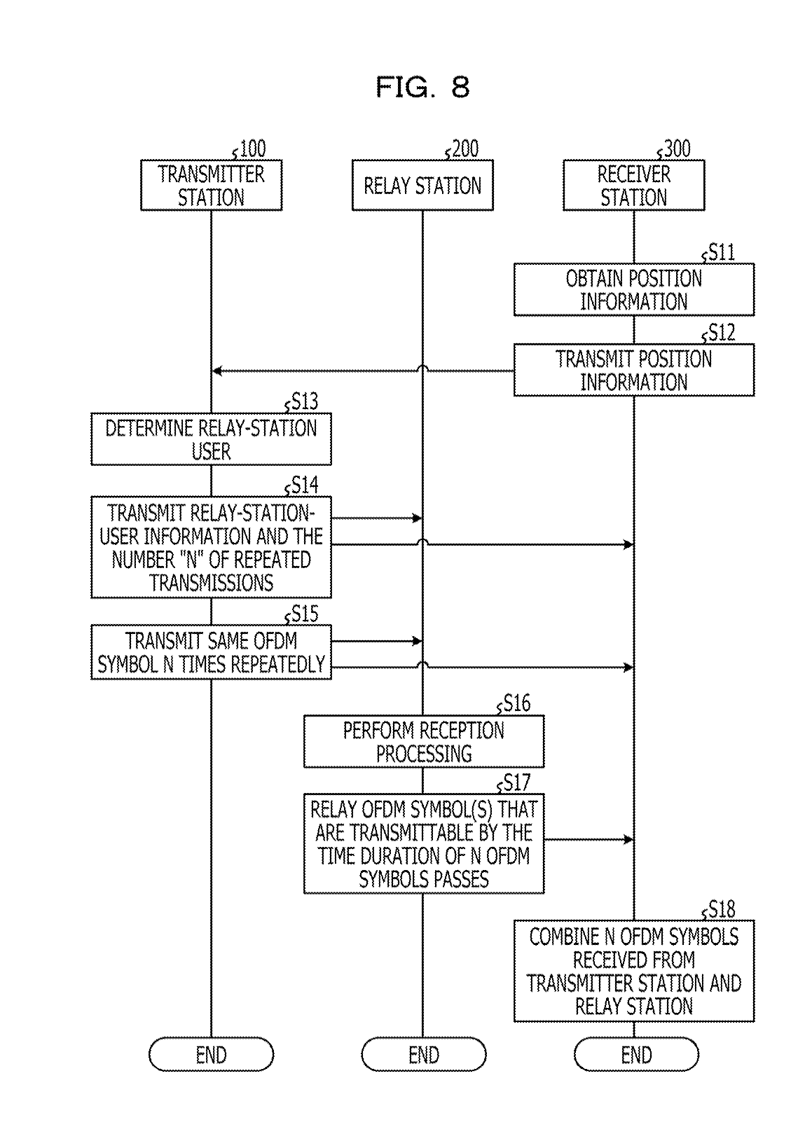

Next, the sequence of processing performed by the wireless communication system 1 according to the first embodiment will be described with reference to FIG. 8. FIG. 8 is a sequence diagram illustrating a procedure of processing performed by the wireless communication system 1 according to the first embodiment. FIG. 8 illustrates a procedure of processing performed by the transmitter station 100, the relay station 200, and the receiver station 300 in the first embodiment.

As illustrated in FIG. 8, in operation S11, the position-information detector 311 in the receiver station 300 obtains position information indicating the location of the receiver station 300. Subsequently, in operation S12, the receiver station 300 transmits the obtained position information to the transmitter station 100. For example, the receiver station 300 transmits a control signal containing the position information to the transmitter station 100.

Subsequently, in operation S13, based on the position information received from the receiver station 300, the relay-station-user selector 120 in the transmitter station 100 determines whether or not the receiver station 300 is to be set as the relay-station user. For example, the relay-station-user selector 120 determines whether or not the receiver station 300 is the relay-station user, based on the distance between the receiver station 300 and the relay station 200. In the example illustrated in FIG. 8, the relay-station-user selector 120 is assumed to set the receiver station 300 as the relay-station user.

In operation S14, the transmitter station 100 transmits, to the relay station 200 and the receiver station 300, relay-station-user information indicating whether or not the receiver station 300 is the relay-station user and the number “N” of repeated transmissions. For example, the transmitter station 100 transmits, to the relay station 200 and the receiver station 300, a control signal containing resource-assignment information, the relay-station-user information, and the number “N” of repeated transmissions.

As a result, the relay station 200 and the receiver station 300 may check whether or not the receiver station 300 is the relay-station user. When the receiver station 300 is the relay-station user, the relay station 200 and the receiver station 300 may also detect the number “N” of times the same signal is transmitted from the transmitter station 100.

In operation S15, during transmission of a control signal and a data signal, the transmitter station 100 transmits the same OFDM symbol N times repeatedly. The relay station 200 and the receiver station 300 receive the OFDM symbols transmitted by the transmitter station 100.

When the relay station 200 receives the OFDM symbols transmitted by the transmitter station 100, the relay station 200 performs predetermined reception processing in operation S16. Examples of the predetermined reception processing include frequency conversion processing, orthogonal demodulation processing, A/D conversion processing, and diffraction-wave elimination processing.

In operation S17, the relay station 200 relays, of the same OFDM symbols contained in the signals received from the transmitter station 100, at least one of the OFDM symbols that are transmittable by the time the duration of the multiple OFDM symbols passes. In this case, the relay station 200 relays the at least one OFDM symbol with a delay corresponding to the amount of delay time obtained by subtracting a predetermined signal processing time from the integer multiple of the duration of the OFDM symbol.

In operation S18, the receiver station 300 combines the signals transmitted by the transmitter station 100 and the relay station 200. More specifically, the receiver station 300 combines the OFDM symbols transmitted by the transmitter station 100 and the OFDM symbols transmitted by the transmitter station 100 and the relay station 200 and spatially multiplexed.

[Other Examples of Signals Transmitted/Received]

The OFDM symbols transmitted by the transmitter station 100 and the relay station 200 and the OFDM symbols received by the receiver station 300 will be described next in conjunction with specific examples other than the examples illustrated in FIGS. 2 to 4.

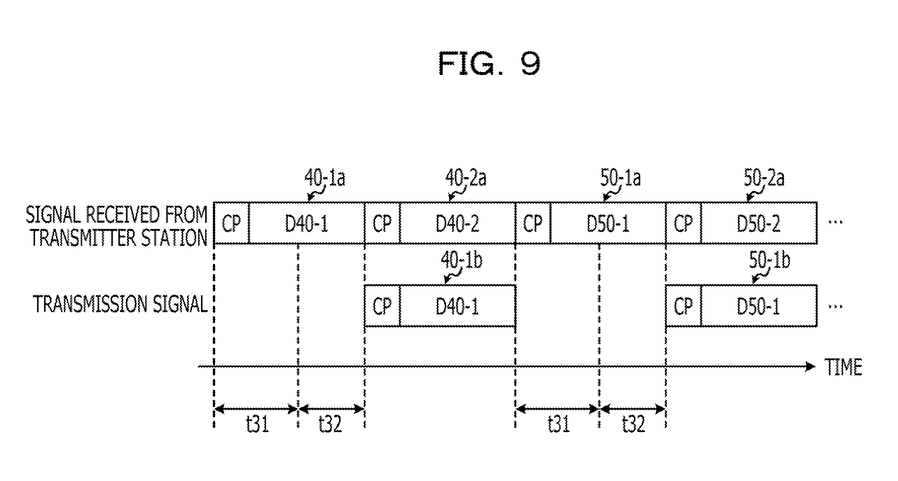

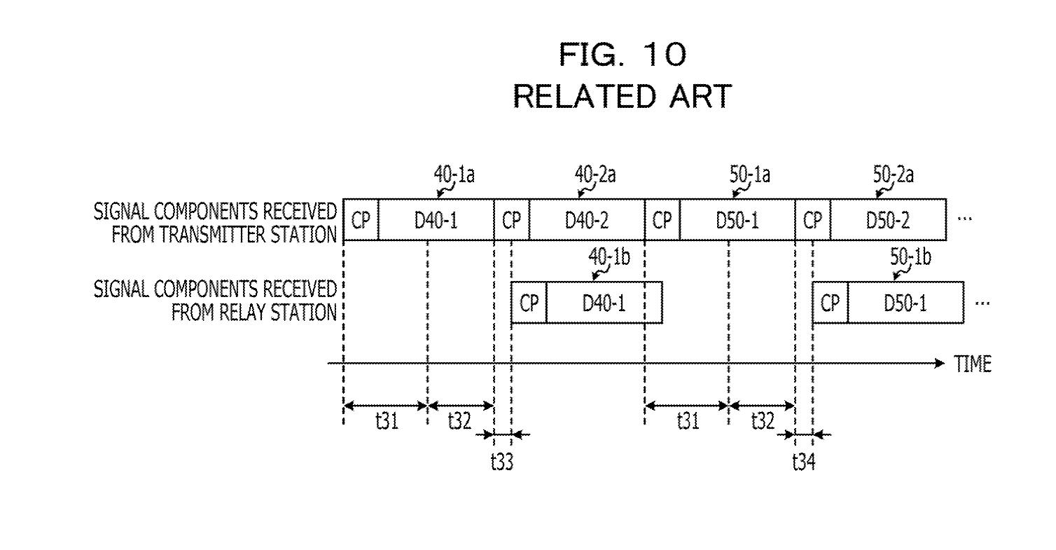

First, a description will be given in conjunction with examples illustrated in FIGS. 9 and 10. FIG. 9 illustrates examples of signals transmitted/received by the relay station 200 in the first embodiment. The upper stage in FIG. 9 illustrates one example of a signal that the relay station 200 receives from the transmitter station 100. The lower stage in FIG. 9 illustrates one example of a signal relayed by the relay station 200.

In the example illustrated in FIG. 9, the transmitter station 100 transmits the same OFDM symbol twice repeatedly. In the example illustrated in the upper stage in FIG. 9, the relay station 200 receives the same OFDM symbols 40-1a and 40-2a and the same OFDM symbols 50-1a and 50-2a from the transmitter station 100. Time “t31” illustrated in FIG. 9 indicates the amount of time taken for the signal processing performed by the relay station 200.

The relay station 200 relays the first OFDM symbol 40-1a of the same OFDM symbols 40-1a and 40-2a received from the transmitter station 100 and does not relay the second OFDM symbol 40-2a of the received OFDM symbols 40-1a and 40-2a. That is, the relay station 200 transmits an OFDM symbol 40-1b that is the same as the OFDM symbol 40-1a received from the transmitter station 100. In this case, the relay station 200 transmits the OFDM symbol 40-1b with a delay corresponding to a time “t32” obtained by subtracting the signal processing time “t31” from the duration of one OFDM symbol.

Similarly, the relay station 200 relays the first OFDM symbol 50-1a of the same OFDM symbols 50-1a and 50-2a received from the transmitter station 100 and does not relay the second OFDM symbol 50-2a of the received OFDM symbols 50-1a and 50-2a. That is, the relay station 200 transmits an OFDM symbol 50-1b that is the same as the OFDM symbol 50-1a received from the transmitter station 100, with a delay corresponding to the time “t32”.

Next, signals received by the receiver station 300 when the signal illustrated in FIG. 9 is relayed by the relay station 200 will be described with reference to FIG. 10. FIG. 10 illustrates examples of signals received by the receiver station 300 in the first embodiment. The upper stage in FIG. 10 illustrates signal components that the receiver station 300 receives from the transmitter station 100 and the lower stage in FIG. 10 illustrates signal components that the receiver station 300 receives from the relay station 200. Times “t33” and “t34” illustrated in FIG. 10 indicate propagation delay differences that occur since the path from the transmitter station 100 to the receiver station 300 and the path from the relay station 200 to the receiver station 300 are different from each other.

As illustrated in FIG. 10, the receiver station 300 receives a signal in which the OFDM symbols 40-1a, 40-2a, 50-1a, and 50-2a transmitted by the transmitter station 100 and the OFDM symbols 40-1b and 50-1b transmitted by the relay station 200 are spatially multiplexed.

Upon receiving the signals illustrated in FIG. 10, the receiver station 300 may extract the OFDM symbols by using the known signals transmitted by the transmitter station 100 or the relay station 200. For example, the receiver station 300 may obtain the OFDM symbol 40-1a and the OFDM symbol in which the OFDM symbol 40-2a and 40-1b are spatially multiplexed. Similarly, the receiver station 300 may obtain the OFDM symbol 50-1a and the OFDM symbol in which the OFDM symbols 50-2a and 50-1b are spatially multiplexed.

The receiver station 300 then combines the thus-obtained OFDM symbols. More specifically, the receiver station 300 combines the OFDM symbol 40-1a with the OFDM symbol in which the OFDM symbols 40-2a and 40-1b are spatially multiplexed and also combines the OFDM symbol 50-1a with the OFDM symbols 50-2a and 50-1b.

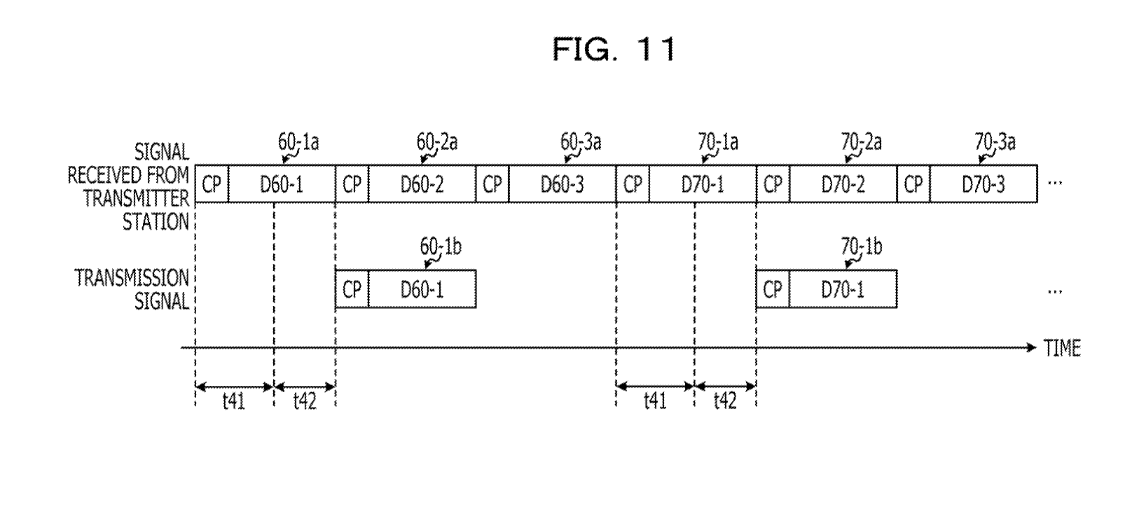

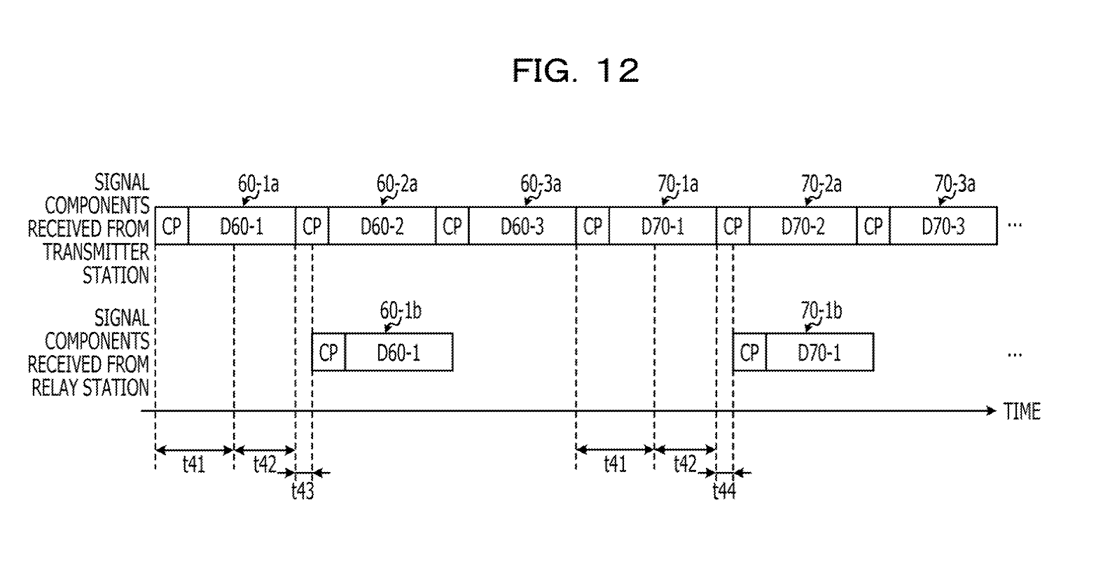

Next, a description will be given in conjunction with examples illustrated in FIGS. 11 and 12. FIG. 11 illustrates examples of signals transmitted/received by the relay station 200 in the first embodiment. The upper stage in FIG. 11 illustrates one example of a signal that the relay station 200 receives from the transmitter station 100. The lower stage in FIG. 11 illustrates one example of a signal relayed by the relay station 200.

In the example illustrated in FIG. 11, the transmitter station 100 transmits the same OFDM symbol three times repeatedly. In the example illustrated in the upper stage in FIG. 11, the relay station 200 receives the same OFDM symbols 60-1a to 60-3a and the same OFDM symbols 70-1a to 70-3a from the transmitter station 100. Time “t41” illustrated in FIG. 11 indicates the amount of time taken for the signal processing performed by the relay station 200.

The relay station 200 may relay the OFDM symbols 60-1a and 60-2a of the same OFDM symbols 60-1a to 60-3a received from the transmitter station 100. However, in the example illustrated in FIG. 11, the relay station 200 relays the first received OFDM symbol 60-1a and does not relay the second and subsequently received OFDM symbols 60-2a and 60-3a. That is, the relay station 200 transmits an OFDM symbol 60-1b that is the same as the OFDM symbol 60-1a received from the transmitter station 100. In this case, the relay station 200 transmits the OFDM symbol 60-1b with a delay corresponding to a time “t42” obtained by subtracting the signal processing time “t41” from the duration of one OFDM symbol.

Similarly, the relay station 200 relays the first OFDM symbol 70-1a of the same OFDM symbols 70-1a to 70-3a received from the transmitter station 100 and does not relay the second and subsequently received OFDM symbols 70-2a and 70-3a. That is, the relay station 200 transmits an OFDM symbol 70-1b that is the same as the OFDM symbol 70-1a received from the transmitter station 100, with a delay corresponding to the time “t42”.

In the example illustrated in FIG. 11, the relay station 200 may relay both the OFDM symbols 60-1a and 60-2a or may relay only the OFDM symbol 60-2a. Similarly, the relay station 200 may relay both the OFDM symbols 70-1a and 70-2a or may relay only the OFDM symbol 70-2a.

Next, signals received by the receiver station 300 when the signal illustrated in FIG. 11 is relayed by the relay station 200 will be described with reference to FIG. 12. FIG. 12 illustrates examples of signals received by the receiver station 300 in the first embodiment. The upper stage in FIG. 12 illustrates signal components that the receiver station 300 receives from the transmitter station 100 and the lower stage in FIG. 12 illustrates signal components that the receiver station 300 receives from the relay station 200. Times “t43” and “t44” illustrated in FIG. 12 indicate propagation delay differences that occur since the path from the transmitter station 100 to the receiver station 300 and the path from the relay station 200 to the receiver station 300 are different from each other.

As illustrated in FIG. 12, the receiver station 300 receives a signal in which the OFDM symbols 60-1a to 60-3a and 70-1a to 70-3a transmitted by the transmitter station 100 and the OFDM symbols 60-1b and 70-1b transmitted by the relay station 200 are spatially multiplexed.

Upon receiving the signals illustrated in FIG. 12, the receiver station 300 combines the OFDM symbol 60-1a, the OFDM symbol in which the OFDM symbols 60-2a and 60-1b are spatially multiplexed, and the OFDM symbol 60-3a and also combines the OFDM symbol 70-1a, the OFDM symbol in which the OFDM symbols 70-2a and 70-1b are spatially multiplexed, and the OFDM symbol 70-3a.

[Advantages of First Embodiment]

As described above, the transmitter station 100 in the first embodiment transmits the same OFDM symbol N times repeatedly. The relay station 200 in the first embodiment relays, of the same OFDM symbols received from the transmitter station 100, any of the OFDM symbols that are transmittable by the time N-times the duration of the OFDM symbol passes after the reception of the first one of the OFDM symbols. With this arrangement, the receiver station 300 in the first embodiment may receive a signal that has no inter-OFDM-symbol interference. Thus, the wireless communication system 1 according to the first embodiment may improve the quality of the signal received by the receiver station 300.

The relay station 200 in the first embodiment performs delay processing so that the difference between the time at which the OFDM symbol transmitted from the transmitter station 100 arrives at the receiver station 300 and the time at which the OFDM symbol transmitted by the relay station 200 arrives at the receiver station 300 is smaller than or equal to the CP duration. With this arrangement, the receiver station 300 may extract a signal for each OFDM symbol even when using any of the known signals transmitted by the transmitter station 100 or the relay station 200.

In addition, based on the position information of the receiver station 300, the transmitter station 100 in the first embodiment determines whether or not the receiver station 300 is to be set as the relay-station user. This arrangement allows the transmitter station 100 to perform processing for repeatedly transmitting the same signal to only the receiver station 300 that is the relay-station user. Thus, it is possible to reduce the amount of processing load and it is also possible to make effective use of frequency resources.

### Second Embodiment

The wireless communication system, the receiver station, and the wireless communication method disclosed herein may also be implemented in various forms other than the above-described embodiment. Accordingly, a description will now be given of a second embodiment of the wireless communication system, the receiver station, and the wireless communication method disclosed herein.

[Delay Processing]

Although an example in which the relay station 200 performs the delay processing and so on by using the known signal processing time has been described in the first embodiment, the relay station 200 may also perform the delay processing and so on by using a result of dynamic measurement of the signal processing time. For example, the relay station 200 may measure the time from when a signal is received by the antenna 201 until the CP addition processing performed by the CP adding unit 262 is completed and may use the result of the measurement as the signal processing time. Such an arrangement allows the relay station 200 to perform the delay processing with high accuracy.

[System Configuration, Etc.]

The elements of the illustrated apparatuses/devices are merely functionally conceptual and do not necessarily have to be physically configured as illustrated. That is, specific forms of separation/integration of the apparatuses/devices are not limited to those illustrated, and all or a portion thereof may be functionally or physically separated or integrated in an arbitrary manner, depending on various loads, a use state, and so on.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
a transmitter station that includes
a first transmitter that transmits a same signal at least twice repeatedly;
a relay station that includes
a receiver that receives the signals transmitted by the transmitter,
a signal processor that performs predetermined signal processing on the signals received by the receiver, and eliminates the later one of two same signals received by the receiver, and
a second transmitter that transmits to a receiver station the earlier one of the two same signals after the signal processing performed by the signal processor.

2. The wireless communication system according to claim 1, wherein the second transmitter transmits, among a plurality of the same signals received by the receiving unit, at least one of the plurality of the same signals that are transmittable by the time a duration of the plurality of the same signals passes after start of the reception of the plurality of the same signals.

3. The wireless communication system according to claim 2, wherein the relay station further includes a delay circuit that delays transmission of the signal by the second transmitter, so that the second transmitter relays the signal at substantially the same timing as timing at which any of the plurality of the same signals is received.

4. The wireless communication system according to claim 1, wherein
the transmitter station further includes a processor that determines, based on position information indicating a location of the receiver station, whether or not the receiver station is to be set as a relay-station user serving as a receiver station for receiving the signal relayed by the relay station;
when the processor determines that the receiver station is set as the relay-station user, the transmitter repeatedly transmits the same signal to only the receiver station; and
the relay station relays only a signal destined for the receiver station determined to be set as the relay-station user by the determining unit.

5. A relay station comprising:
a receiver that receives signals transmitted by a transmitter station;
a signal processor that performs predetermined signal processing on the signals received by the receiver, and eliminates the later one of two same signals received by the receiver; and
a transmitter that transmits the earlier one of the two same signals to a receiver station after the signal processing performed by the signal processor.

6. A receiver station comprising:
a receiver that receives, a first signal transmitted earlier of same signals transmitted twice repeatedly by a transmitter station, and then receives a third signal in which a second signal transmitted later of the same signals transmitted twice repeatedly by the transmitter station and the first signal relayed by a relay station are spatially multiplexed; and
a processor that combines the first signal and the third signal received by the receiver.

7. A wireless communication method for a wireless communication system in which a transmitter station and a receiver station are capable of performing a wireless communication via a relay station, the method comprising:
transmitting, at the transmitter station, a same signal at least twice repeatedly;
receiving, at the relay station, the signals transmitted in the transmitting;
performing, at the relay station, predetermined signal processing on the signals received in the receiving; and
eliminating, at the relay station, the later one of two same signals received in the receiving and relaying the earlier one thereof after the signal processing is performed.
